(19) United States
(12) Patent Application Publication
(10) Pub. No.: US 2012/0104284 A1
(43) Pub. Date: May 3, 2012

(54) PATTERNING DEVICE FOR GENERATING A PATTERN IN AND/OR ON A LAYER

(75) Inventor: Coen Adrianus Verschuren, Eindhoven (NL)

(73) Assignee: KONINKLIJKE PHILIPS ELECTRONICS N.V., Eindhoven (NL)

(21) Appl. No.: 13/382,766

(22) PCT Filed: Jul. 5, 2010
(86) PCT No.: PCT/IB2010/053073

§ 371 Date: Jan. 6, 2012

(30) Foreign Application Priority Data
Jul. 7, 2009 (EP) 09164709.9

(51) Int. Cl. B01J 19/12

(52) U.S. Cl. 250/492.1

(57) ABSTRACT

The invention relates to a patterning device (10, 12) for generating a pattern (20, 22, 24) in and/or on a layer (32, 34) via a condensed light beam (40). The patterning device comprises a light source (50) for generating the condensed light beam (40), a diffractive optical element (60) for splitting the condensed light beam (40) into a plurality of condensed sub-beams (40A, 40B, 40C) and positioning means (70) for positioning the layer relative to the plurality of condensed sub-beams for generating the pattern. The condensed sub-beams are configured for generating the pattern in and/or on the layer. At least two sub-beams of the plurality of condensed sub-beams comprise substantially equal intensity. An effect of the patterning device according to the invention is that a single condensed light beam is split into a plurality of condensed sub-beams to generate a multi-spot patterning for patterning relatively large areas using the plurality of condensed sub-beams. As such, the patterning time for filling that area in the pattern and for generating the pattern in and/or on the layer is considerably reduced.

### FIELD OF THE INVENTION

The invention relates to a patterning device for generating a pattern in and/or on a layer.

### BACKGROUND OF THE INVENTION

Patterning devices for generating a pattern in and/or on a layer of a substrate using a condensed light beam are known in the art. These known patterning devices use, for example, laser light sources to generate a condensed light beam. The condensed light beam has sufficient energy density to locally, for example, damage the layer to make the pattern visible. As such the patterning device comprises means to move the condensed light beam across the surface of the substrate to generate or write the pattern.

Organic light emitting diode devices (further also referred to as OLED devices) are in many ways considered as the future in various lighting applications. They may, for instance, be used to create ambient lighting. OLED devices typically comprise a cathode, an anode, an emissive organic layer. These parts are typically stacked on a substrate. The emissive layer is manufactured of organic material that can conduct an electric current. When a voltage is applied across the organic material via the cathode and anode, a current runs through the organic material which generates photons which are emitted from the OLED device. Recently patterning of OLED devices is described. Full 2-dimensional grey-level pictures may be patterned in a single OLED device, while maintaining all intrinsic advantages of OLED devices, for instance, being appealing, being a diffuse area light source and so on.

A first example of a patterned OLED device may be found in the non-pre-published patent application of the applicant, attorney docket number PH011821 in which the pattern in the OLED device is generated as deformations in a light-reflecting layer. A second example of the patterned OLED device may be found in the non-pre-published patent application of the applicant, attorney docket number PH012033 in which the pattern in the OLED device is generated in a current supporting layer by altering a current support characteristic of the current support layer via impinging condensed light, while substantially not altering the organic light emitting material, the anode layer nor the cathode layer. The current support characteristic locally determines the current flowing through the organic light emitting material in operation. These patterned OLED devices are generated using a condensed light beam having a relatively narrow spot diameter and a relatively high energy density to ensure accurate details and high contrast.

A disadvantage of known patterning devices is that the generation of a pattern takes too long.

### SUMMARY OF THE INVENTION

It is an object of the invention to provide a patterning device in which the patterning time, being the time to generate a specific pattern, is reduced.

According to a first aspect of the invention the object is achieved with a patterning device as claimed in claim 1.

The patterning device for generating a pattern in and/or on a layer according to the first aspect of the invention comprises:

a light source for generating the condensed light beam for generating the pattern,
a diffractive optical element for splitting the condensed light beam into a plurality of condensed sub-beams configured for generating the pattern in and/or on the layer, at least two sub-beams of the plurality of condensed sub-beams comprising substantially equal intensity, and

positioning means for positioning the layer relative to the plurality of condensed sub-beams for generating the pattern.

An effect of the patterning device according to the invention is that a single condensed light beam is split into a plurality of condensed sub-beams via a diffractive optical element in which the plurality of condensed sub-beams are used for generating the pattern. As such, especially when imaging a relatively large area in a pattern with a substantially similar structure such as filling large areas in an image, the patterning time for filling that area in the pattern and for generating the pattern in and/or on the layer is considerably reduced. In known patterning devices, for example, the dimensions or width of the condensed light beam may be adapted to increase the patterning spot of the condensed light beam and as such reduce the patterning time. However, this increase of the dimensions or width of the condensed light beam requires a considerable increase in the power produced by the light source, because the required power in the condensed light beam scales quadratically with the spot diameter. This means that for a substantial reduction in patterning time, a condensed light beam having a much higher power is required which clearly adds to the costs of the patterning device. Moreover, any scanning and/or imaging optics which may be present in the system may need to operate in a large dynamic range of light intensities and should be able to withstand a severe thermal load in such known systems. Finally, the thermal load on the layer in and/or on which the pattern is to be generated increases due to this increased dimension of the condensed light beam in such known systems. This may not be preferred when patterning some type of the layers, for example, when patterning layers in OLED devices. Using the patterning device according to the invention reduces the time required to generate a pattern in and/or on the layer. Furthermore, the splitting of the condensed light beam into condensed sub-beams ensures that the increase of the required power in the condensed light beam remains within limits as the required power of the condensed light beam only scales linearly with the number of condensed sub-beams which are generated by the diffractive optical element. As such, also an increase in costs of the patterning device remains limited when using the diffractive optical element to reduce the patterning time.

An alternative method of reducing the patterning time would be to increase the intensity of the condensed light beam while simultaneously increasing the scanning speed of the condensed light beam across the layer. However, this increased scanning speed reduces the accuracy of the writing of the pattern and is not preferred. Furthermore, this increased intensity of the condensed light beam may locally lead to damage of the layer in and/or on which the pattern is created. Especially when using the patterning device to pattern any of the previously indicated patterned OLED devices, the layer of the OLED device in and/or on which the pattern is generated may be relatively easily damaged, due to too high local intensity of the condensed light beam. This may lead to an unusable patterned OLED. By splitting the condensed light beam into a plurality of condensed sub-beams using the diffractive optical element according to the invention, the intensity per condensed sub-beam may remain within the limits which prevent the condensed sub-beam from damaging, for example, such an OLED device while still the time required for generating the pattern is substantially reduced.

In the paper “Two-Dimensional Optical Storage: High-speed read-out of a 50 GByte single-layer optical disc with a 2D format using λ=405 nm and NA=0.85” of Bruls et al., Jpn J Appl Phys Part 1, Vol. 44, No 5B, pages: 3547-3553 (2005), a diffraction grating is disclosed in which a laser-beam for read-out of an optical disc is split into an array of laser beams each having substantially identical intensity for parallel read-out of the optical disc. Although this cited document is related to a technical field of optical disc read-out devices, which is a completely different technical field compared to the field of patterning devices for generating a pattern in and/or on a layer according to the current invention, the grating defined in this paper may be used to split the condensed light beam into a plurality of condensed sub-beams which may be used to generate the pattern. The paper discloses the use of a grating in which the energy is equally distributed over the different grating orders and as such at least two condensed sub-beams comprise substantially equal intensity. The inventor has realized that such a diffraction grating may beneficially be used when patterning a layer of a device, especially when the patterning requirements include having a narrow condensed light beam having relatively high energy to generate the pattern in and/or on the layer.

In an embodiment of the patterning device, the diffractive optical element is configured for splitting the condensed light beam into a one-dimensional array of condensed sub-beams or into a two-dimensional array of condensed sub-beams, a further plurality of the condensed sub-beams of the one-dimensional array of condensed sub-beams or of the two-dimensional array of condensed sub-beams comprising substantially equal intensity. With the term “substantially equal intensity” is meant that the intensity of the condensed sub-beams is equal within a few percent of the light intensity of the individual sub-beams. The further plurality may represent two or more condensed sub-beams of the one-dimensional array, or may represent two or more condensed sub-beams of the two-dimensional array, or may represent two or more condensed sub-beams in a row or column of the two-dimensional array. In a preferred embodiment, all of the condensed sub-beams of the one-dimensional array of condensed sub-beams or of the two dimensional array of condensed sub-beams comprise substantially equal intensity. A benefit of this patterning device is that the efficiency of the conversion from a single condensed light beam into the plurality of condensed sub-beams is high, as substantially all light impinging on the diffractive optical element is redistributed into the condensed sub-beams. Only some light from the condensed light beam may be lost as stray-light. Stray-light may be defined as light having an intensity below 10% of the intensity of a condensed sub-beam.

Using such a splitting diffractive optical element, not just one, but a one-dimensional or two-dimensional array of spots may be used to generate the pattern. In such a patterning device, an edge of a structure to be patterned may, for example, be patterned using a single spot to ensure an accurate and well-defined line or edge of the structure. A larger area, for example, being the area surrounded by the edge defined by the single spot, may be patterned using this diffractive optical element which generates a further plurality of spots having substantially equal intensity to simultaneously pattern a relatively large part of the area.

In an embodiment of the patterning device, the diffractive optical element comprises a binary phase grating, and/or a binary amplitude grating, and/or a variable phase grating, and/or a variable amplitude grating, and/or a holographic phase optical element, and/or a holographic amplitude optical element, and/or a holographic phase grating, and/or a holographic amplitude grating, and/or a spatial light modulator. Such diffractive optical elements may relatively easily be designed using optical design software such as “Gsolver”. Using such optical design software, such diffractive optical element may be produced to have a high splitting efficiency such that more than 90% of the light of the condensed light beam is redistributed across the plurality of condensed sub-beams. Further benefits when using such diffractive optical elements is that they have relatively low production cost as they may be manufactured via well known injection molding techniques in, for example, durable, transparent plastics material using, for example, a metal master, or, for example, using imprint. The spatial light modulator enables a flexible diffractive optical element which may be altered by altering the spatial light modulator. Such spatial light modulator may, for example, be an array of liquid crystal cells which may be controlled to locally vary the refractive index of the liquid crystal cells to obtain the plurality of condensed sub-beams.

In an embodiment of the patterning device, each of the condensed sub-beams comprising substantially equal intensity comprise an intensity sufficient to generate the pattern in and/or on the layer. As such each one of the condensed sub-beams in the array of condensed sub-beams may be used simultaneously to generate the pattern. As such, a real multi-spot patterning may be done for patterning relatively large areas using the plurality of condensed sub-beams at a predefined regular interval.

In an embodiment of the patterning device, an angle between each pair of adjacent condensed sub-beams in a row of condensed sub-beams is substantially identical. This substantially results in equal spacing of the condensed sub-beams in one direction. In another direction, for example, in a direction perpendicular to the one direction, the spacing may be equal or may be different. A benefit of this patterning device is that the spacing of the impinging condensed sub-beams on the layer results in a plurality of substantially equally spaced spots. The distance between the spots may be altered by changing the distance between the diffractive optical element and the layer, or by rotating the diffractive optical element such that the condensed light beam impinges on the diffractive optical element at an angle which optically reduces a distance between the grating structures which alters the pattern of condensed sub-beams generated by the diffractive optical element. For the latter, the rotation preferably is within the depth of field of the condensed light beam. Alternatively the distance between the spots on the layer while writing may be altered by rotating the diffractive optical element in a layer substantially coinciding with the grating. Although in such an embodiment, the physical distance between the condensed sub-beams are not altered (because the grating is located at the same distance from the layer and comprises the same grating), but the distance between the condensed sub-beams as perceived in the scan direction is reduced. If the condensed sub-beams are arranged in a line of condensed sub-beams, this rotating in the layer substantially coinciding with the grating causes this line of condensed sub-beams to no longer be arranged substantially perpendicular to the scan-direction of the patterning device, but causes this line of condensed sub-beams to form an angle with the scan-direction of the patterning device—as such effectively reducing the distance between the spots on the layer when writing. Finally, a different diffractive optical element may be used, for example, replacing the previous diffractive optical element to alter the distance between the spots.

In an embodiment of the patterning device, the diffractive optical element is configured for adapting a number of the condensed sub-beams and/or an intensity of the condensed sub-beams, wherein the diffractive optical element comprises pixels comprising translucent material comprising an adaptable refractive index of the translucent material. Such translucent material may, for example, be sensitive to the local electrical field which may be used to locally switch the refractive index of the translucent material to alter the characteristics of the pixels and as such of the diffractive optical element. An electrical configuration for switching the refractive index material may be similar to the electrical configuration used in liquid crystal display devices for switching the liquid crystals to generate a difference in transmission of the liquid crystal display cell. By altering the characteristics of the pixels, the number of condensed sub-beams and/or the intensity in the condensed sub-beams may be altered dynamically by the diffractive optical element. The diffractive optical element may comprise a spatial light modulator which comprises pixels being configured for locally altering the translucent material.

In an embodiment of the patterning device, the diffractive optical element is configured for adapting a number of the condensed sub-beams and/or an intensity of the condensed sub-beams, wherein the diffractive optical element comprises a plurality of different gratings each generating a predefined number of condensed sub-beams and/or a predefined intensity of the condensed sub-beams, the diffractive optical element being movable with respect to the condensed light beam for aligning the condensed light beam with one of the plurality of different gratings. By moving the diffractive optical element, the required grating from the plurality of different gratings may be chosen to generate the number of condensed sub-beams and/or the intensity of the condensed sub-beams which are required for the patterning of the pattering device.

In an embodiment of the patterning device, the diffractive optical element is configured for being movable into the optical path of the condensed light beam for generating the plurality of condensed sub-beams, and for being movable out of the optical path of the condensed light beam. A benefit of this patterning device is that the patterning device may both use the single condensed light beam for generating the pattern, for example, when generating the edges of a structure. Alternatively, the patterning device may slide the diffractive optical element into the optical path of the condensed light beam to generate the plurality of condensed sub-beams for patterning larger areas, for example, to fill a structure from which the edges are produced using the single condensed light beam. Typically, such a patterning device in which the diffractive optical element may be movable into the optical path of the condensed light beam also requires means for adapting the power of the condensed light beam which typically is too high when not split into the plurality of condensed sub-beams. So either the power of the light source may be adapted, or the condensed light beam may be weakened. Alternatively, the scanning speed may be increased such that the power density of the condensed light beam does not exceed a certain damaging limit of the layer. In an alternative embodiment, the patterning device may comprise two light sources, a first light source for generating a first condensed light beam having an intensity for generating the pattern in and/or on the layer, and a second light source configured for being split into the plurality of condensed sub-beams via the diffractive optical element, in which most of the condensed sub-beams in the plurality of condensed sub-beams have an intensity for generating the pattern in and/or on the layer. As such, no altering of intensity of the condensed light beam is required; this benefits the stability of the patterning device.

In an embodiment of the patterning device, the layer is part of an organic light emitting diode device. As indicated before, recently the use of organic light emitting diode devices for generating and displaying patterns has become popular. Currently, it is possible to generate a full two-dimensional grey-level picture in a single OLED device, while maintaining all intrinsic advantages of OLED devices, for instance, being appealing, being a diffuse area light source, and so on.

In an embodiment of the patterning device, the layer is a light-reflecting layer of the organic light emitting diode device, the patterning device being configured for generating local deformations of the light-reflective layer for generating the pattern. In a preferred embodiment of the patterning device, the layer is only locally deformed to generate pixels of the pattern. This ensures that the layer, which typically is a conductive layer, still conducts across the whole layer. However, minute holes or cracks may locally be present as long as they do not obstruct the conductivity across the remainder of the layer such that the overall conductivity parallel to the layer remains in tact. For example, minute holes or cracks having dimensions for example, smaller than 1/100 of the height of the smallest characters or structures patterned may not be visible and may not visibly obstruct the conductivity across the remainder of the layer. The light-reflecting layer typically is a cathode layer of the OLED device. At least a part of the anode layer is configured to be substantially transparent to the electro-magnetic radiation generated by the OLED device. The light-reflective layer is preferably not a transparent layer—although transparent layers may reflect some of the impinging light.

In an embodiment of the patterning device, the layer is a light-emitting layer of the organic light emitting diode device, the patterning device being configured for locally damaging the light-emitting layer for generating the pattern. Typically, this damaged part of the light-emitting layer does not conduct any current and as such does not consume any power from the OLED device. As such, the pattern generated via damaging of the light-emitting layer still results in an energy-efficient OLED device.

In an embodiment of the patterning device, the layer is a current support layer of the organic light emitting diode device, the patterning device being configured for locally altering a current support characteristic of the current support layer while not substantially altering an organic light emitting material, an anode layer nor a cathode layer, the current support characteristic locally determining the current flowing through the organic light emitting material in operation. The current support layer may be any of the layers chosen from the list comprising: a current blocking layer, an interface layer of the current blocking layer, a hole blocking layer, an electron blocking layer, an electron injection and/or transporting layer, an interface of the electron injection layer, a injection inhibition layer, an interface layer of the injection inhibition layer, a hole injection and/or transporting layer, an interface of the hole injection layer, an interface layer of the cathode layer, an interface layer of the anode layer and a host layer. Any of a plurality of these layers may be present in the organic light emitting device to locally determine the current flowing through the organic light emitting material. The pattern generated in the current support layer locally alters the current support characteristic which results in a pattern being clearly visible via light intensity variations caused by the locally different current intensities through the light emitting layer when the OLED device is switched on—that is, when the OLED device is connected to a power source for emitting light. By not altering the light emitting layer itself and by not altering the anode layer nor the cathode layer, the pattern is substantially invisible when the OLED device is not switched on—that is, when it is not connected to the power source for emitting light.

In an embodiment of the patterning device, the patterning device is configured for generating the pattern in and/or on the layer through an encapsulation of the organic light emitting diode device. Organic light emitting diode devices are typically encapsulated to protect the devices from environmental influences such as air, water and moisture. These influences may cause the growth of so called black spots in OLED devices. At the location of the black spots, the organic light emitting layer reacts with locally present moisture and becomes locally defective and unable to emit light from the defective location. More prominent is the damage to the cathode layer due to the present of the moisture as the cathode layer reacts with the moisture and subsequently is unable to locally inject current into the organic light emitting layer. Preferably, the organic light emitting diode devices are fully sealed as a last step of the production process, for example, in the encapsulation. For generating the pattern, the encapsulated organic light emitting diode device may comprise a window through which the condensed light beam may enter the encapsulation without breaking the seal against the environment while still being able to pattern a layer in the encapsulated organic light emitting diode device. For the patterning device to be able to generate the pattern through the encapsulation, some flexibility on the focussing characteristics of the patterning device may be required as the distance between the imaging optics of the patterning device when the encapsulation is present may be larger. When the pattern has to be generated through the encapsulation without damaging the light emitting layer, the condensed light beam may enter at the rear of the OLED device being a side of the OLED device which does not emit light. In such an embodiment, the patterning may be done on the cathode layer by generating local deformations in the cathode layer which are clearly visible from the front of the OLED device being a side of the OLED device which emits the light. The encapsulation may locally be transmissive to the light of the condensed light beam and of the condensed sub-beams. For example, the encapsulation may comprise a specific window for generating the pattern in which this specific window allows, for example, ultraviolet or infrared light to pass the specific window which may be used to generate the pattern in and/or on the layer of the OLED device. The specific window may be configured to block any visible light or any light generated by the OLED device, but this is not essential. The remainder of the encapsulation may be transmissive substantially only to the light generated by the OLED device such that the light of the OLED device may be emitted from the OLED device. This specific window for generating the pattern may, for example, be located in the encapsulation at an opposite side of the light-reflective layer as where the light-emitting layer is located—typically indicated as the rear of the OLED device.

In an embodiment of the patterning device, a density of the local deformations of the light-reflective layer, and/or a dimension of the local deformations of the light-reflective layer, and/or a density of the local damages to the light-emitting layer, and/or a density of local altering of the current support characteristic of the current support layer, and/or a level of altering of the current support characteristic of the current support layer constitutes a perceived grey-level. Altering the density or dimensions of the local deformations of the light-reflective layer may be used to alter the perceived grey-levels of the local deformations. The different dimensions may be generated by locally adapting the power of the condensed light beam which may generate deformations having a different height—being a dimension substantially perpendicular to the light-reflective layer—or having a different width—being a dimension substantially perpendicular to the light-reflective layer. Also by altering the density of the damages to the light-emitting layer the perceived grey-levels may be altered. In addition, by altering the density or level of the local altering of the current support characteristic of the current support layer, the perceived grey-levels may be adapted.

In an embodiment of the patterning device, the light source is a laser light source and/or a laser diode. A benefit of this patterning device is that the laser light source generates a relatively well defined condensed light beam which, due to its coherence, may relatively easily be split into the plurality of condensed sub-beams using a diffraction grating. Furthermore, laser light sources and especially laser diodes are relatively easily available, compact and relatively cheap, such that the cost of the patterning device remains within limits.

In an embodiment of the patterning device, the light source is configured for generating a condensed light beam and/or condensed sub-beams in a range between 320 nanometers and 2000 nanometers. Generally using a wavelength in which laser light sources are commonly available enables relatively simple and cheap systems for generating the pattern into the light-reflective of the light emitting diode device. Such wavelength may, for example, be 405 nanometers emitting laser diode or a 532 nanometers emitting YAG laser. Laser systems operating in the infrared part of the spectrum can be used as well, since the patterning relies on a localized heating of the light-reflective layer.

In an embodiment of the patterning device, the patterning device comprises focusing means for controlling a focus location of the condensed light beam and/or condensed sub-beams. A benefit of the patterning device is that in such an arrangement, the condensed light beam and/or condensed sub-beams may be focused at a different location and as such, for example, apply the condensed light beam and/or condensed sub-beams through an encapsulation of the OLED device. Such a patterning device may be used during the production of the OLED device, after the OLED device has been produced and even after the OLED device has been encapsulated. Due to the variable location of the focus of the condensed light beam and/or condensed sub-beams, the patterning device may adapt to the situation and may be able to either focus through the anode and/or cathode layer and may, for example, be also focused through the encapsulation of the OLED device. The latter enables to fully finish the production of the OLED device and encapsulate the OLED device before adapting the pattern.

In an embodiment of the patterning device, the patterning device comprises means for controlling an energy level of the condensed light beam and/or condensed sub-beams, and/or a color of the condensed light beam and/or condensed sub-beams, and/or a speed for altering a position of the layer relative to the condensed light beam and/or condensed sub-beams. The inventors have found that the perceived grey levels may be altered by altering a density and/or intensity of the local pattern. This may be controlled using an energy level of the condensed light beam and/or via a color of the condensed light beam and/or via a speed in which the position of the layer relative to the condensed light beam and/or the condensed sub-beams is altered—further also indicated as scanning speed.

In an embodiment of the patterning device, the patterning device further comprises input means for accepting an input-pattern for being generated as the pattern in and/or on the layer, and comprises conversion means for converting the input-pattern into a positioning of the condensed light beam and/or the condensed sub-beams relative to the layer, and/or into a spot-size of the condensed light beam and/or condensed sub-beams, and/or into an intensity variation of the condensed light beam and/or condensed sub-beams, and/or into a color variation of the condensed light beam, and/or condensed sub-beams for generating the pattern. The input means for accepting the input-pattern may be a computer which uses a specific or generic format in which the input-pattern is provided by a user to the patterning device and in which the computer comprises conversion means for converting the provided input-pattern into commands and/or driving signals for the patterning device to generate the pattern in and/or on the layer, for example, of the OLED device. Such a patterning device would enable a patterning in which no masks are required which reduces the cost of the patterning device. Furthermore, the input means for accepting the input-pattern enable to use this patterning device also to generate a relatively small volume of patterned layers, for example, a small batch of OLED devices which comprise a customer specific pattern. The specific pattern may be provided electronically by the customer via the input means. The input means may also be connected to a network environment, for example, the internet. In such an embodiment, a customer may order his customized patterned layer simply via internet and may upload the required input-pattern to a server of the manufacturer. After the layer is patterned by the patterning device, the patterned device, for example, the patterned OLED device may be shipped directly to the customer.

In an embodiment of the patterning device, the input-pattern comprises a digital representation of the pattern. A benefit of such embodiment is that it allows an easy user interface. As described above, by providing a digital representation of the input-pattern to the patterning device, for example, via uploading the digital representation of the input-pattern to the server, the user may relatively simply request a personalized patterned OLED device via an internet connection. The digital representation may be in different formats in which the patterning device or the server or a local computer may, for example, additionally comprise format converting software to convert the provided digital representation of the pattern into a representation which may directly be used by the patterning device for generating the pattern in and/or on the layer.

### BRIEF DESCRIPTION OF THE DRAWINGS

These and other aspects of the invention are apparent from and will be elucidated with reference to the embodiments described hereinafter.

In the drawings:

FIG. 1 shows a schematic cross-sectional view of a patterning device according to the invention,

FIGS. 2A and 2B show a schematic view of a further embodiment of the patterning device according to the invention,

FIG. 3A shows a schematic view of the diffractive optical element for splitting the condensed light beam into condensed sub-beams, and FIGS. 3B to 3D indicate the spots which are distributed on the layer while writing the pattern using the diffractive optical element,

FIGS. 4A, 4B and 4C show schematic cross-sectional views of an OLED device comprising local deformations in and/or on a light-reflective layer, representing the pattern, and comprising local damaging of the light emitting layer, representing the pattern,

FIGS. 5A and 5B show a detailed representation of the local deformations, and

FIG. 6 shows a schematic cross-sectional view of an OLED device in which the current support characteristics may be altered to generate the pattern.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF EMBODIMENTS

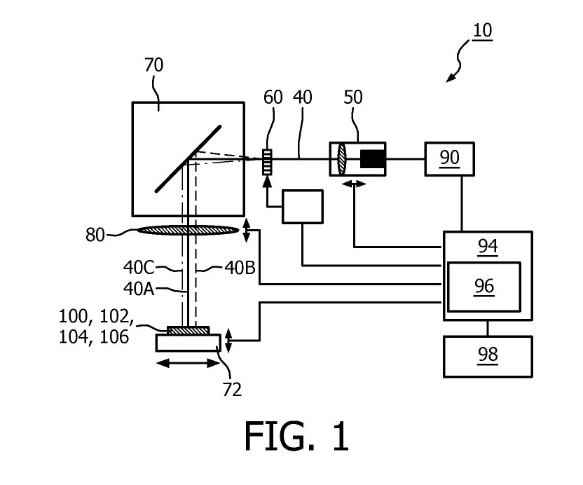

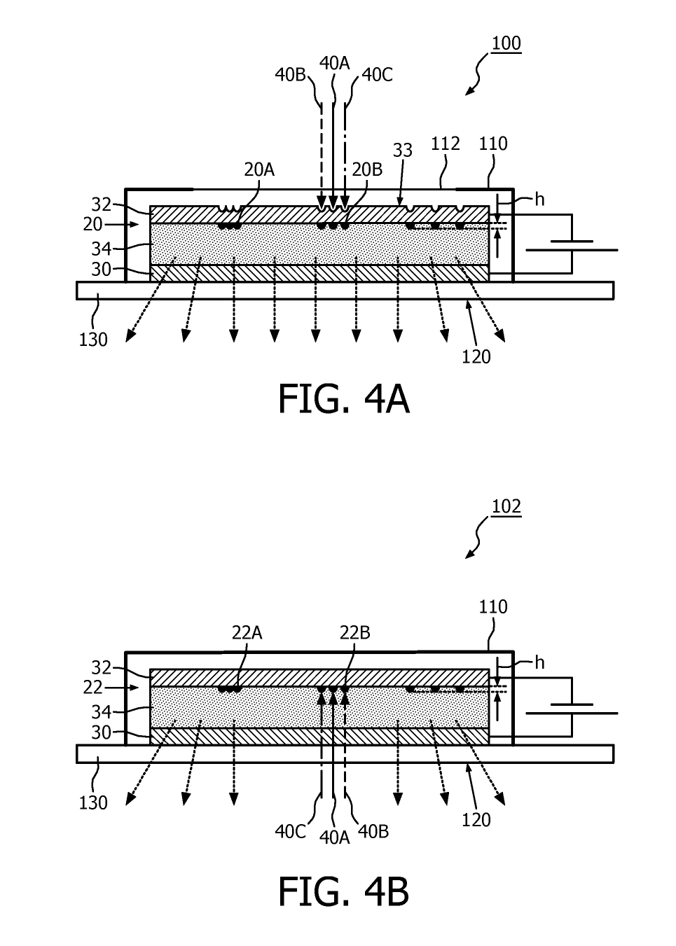

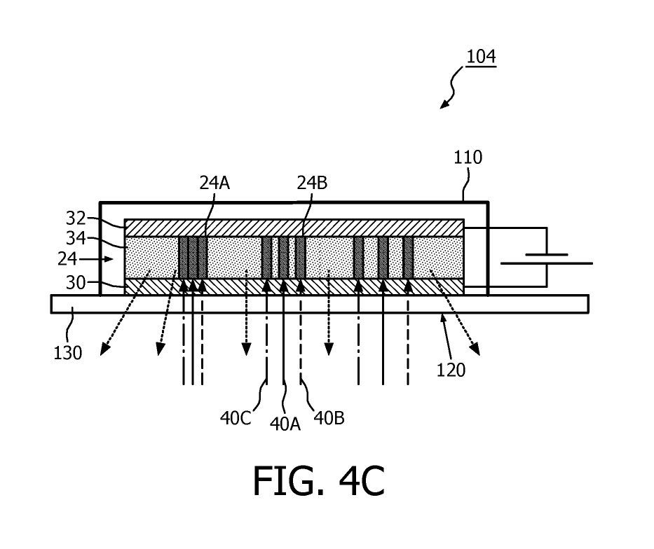

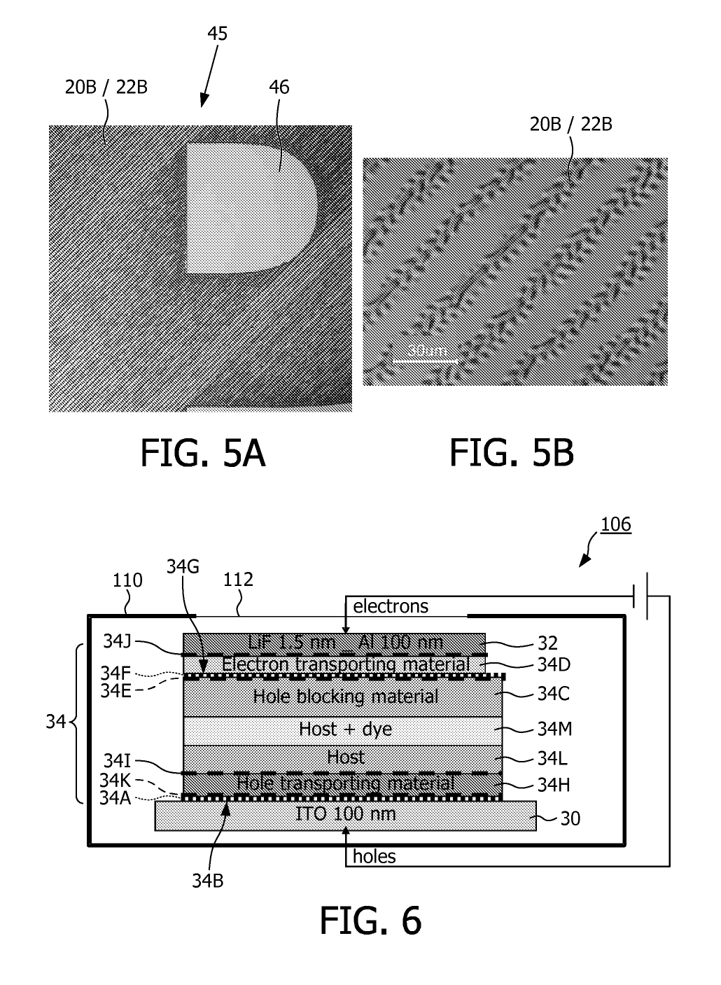

FIG. 1 shows a schematic cross-sectional view of a patterning device 10 according to the invention for generating a pattern 20, 22, 24 (see FIGS. 4 and 5) in and/or on a layer 32, 34 (see FIGS. 4 and 6). The patterning device 10 comprises a light source 50 for generating a condensed light beam 40 and comprises scanning means 70, for example, a movable mirror 70 or a movable exposure chuck 72 on which a substrate comprising the layer 32, 34 may be located. The patterning device 10 further comprises a diffractive optical element 60 for splitting the condensed light beam 40 into a plurality of condensed sub-beams 40A, 40B, 40C. Via the diffractive optical element 60, a single condensed light beam 40 is split into a plurality of condensed sub-beams 40A, 40B, 40C such that the plurality of condensed sub-beams may be used for generating the pattern 20, 22, 24. As such, especially when having to generate a pattern 20, 22, 24 comprising a relatively large area of substantially equal grey-area, the area may be patterned more quickly when using the plurality of condensed sub-beams 40A, 40B, 40C. As such, the patterning time for filling that relatively large area and for generating the pattern 20, 22, 24 in and/or on the layer 32, 34 is considerably reduced. Preferably the intensity of the plurality of condensed sub-beams 40A, 40B, 40C is substantially equal, such that the plurality of condensed sub-beams 40A, 40B, 40C enable a real multi-spot patterning for patterning the relatively large area on the layer 32, 34 using the plurality of condensed sub-beams 40A, 40B, 40C at a predefined regular interval from each other.

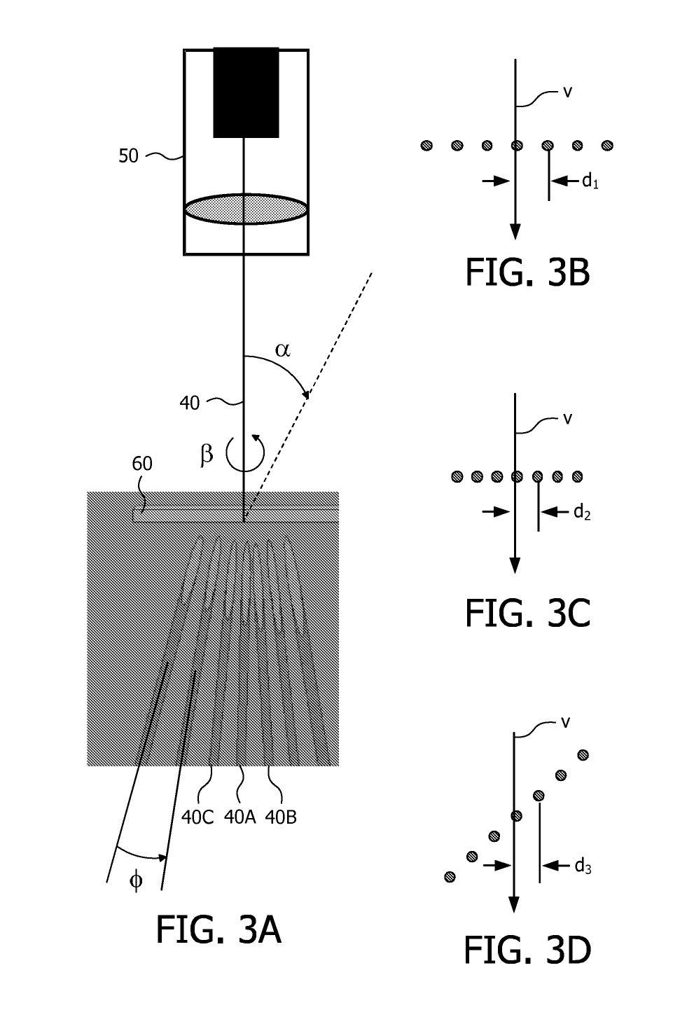

The diffractive optical element 60 may, for example, be a binary phase grating 60, and/or a variable phase grating 60 and/or a holographic grating (60). The manufacturing of such gratings may be done efficiently using optical design software, such as “Gsolver”. Such gratings 60 may generate a one-dimensional array of condensed sub-beams 40A, 40B, 40C or a two-dimensional array of condensed sub-beams 40A, 40B, 40C. Preferably each of the generated condensed sub-beams 40A, 40B, 40C has substantial equal intensity which may be possible within a few percent of the light intensity of the individual sub-beams when designing the gratings using the optical design software. The interval between the condensed sub-beams 40A, 40B, 40C either in the one-dimensional array or in the two-dimensional array may be determined by the diffractive optical element 60. Preferably an angle φ (see FIG. 3A) between two adjacent condensed sub-beams 40A, 40B, 40C in a row of condensed sub-beams 40A, 40B, 40C is substantially constant such that the pattern 20, 22, 24 generated by the row of condensed sub-beams 40A, 40B, 40C is a substantially regular pattern 20, 22, 24. The actual distance between two adjacent condensed sub-beams 40A, 40B, 40C at the layer 32, 34 determines a density of the pattern 20, 22, 24 generated by the plurality of condensed sub-beams 40A, 40B, 40C. The density of the pattern 20, 22, 24 determines the perceived grey-level of the generated pattern 20, 22, 24 and may be used to generate a range of grey-levels in an image produced by the pattern 20, 22, 24. This distance between two adjacent condensed sub-beams 40A, 40B, 40C at the layer 32, 34 may be altered by altering a distance between the diffractive optical element 60 and the layer 32, 34, or by rotating the diffractive optical element 60 such that the condensed light beam 40 impinges on the diffractive optical element 60 at a further angle α (see FIGS. 3A and 3C) which optically reduces a distance between the grating structures in the diffractive optical element 60 which alters the pattern of condensed sub-beams 40A, 40B, 40C generated by the diffractive optical element 60. Alternatively, a rotating of the diffractive optical element 60 in a plane coinciding with the grating of the diffractive optical element 60 may result in a varying of the distance between two adjacent condensed sub-beams 40A, 40B, 40C at the layer 32, 34 with respect to the moving direction of the adjacent condensed sub-beams (see FIG. 3C in which v indicates the moving direction of the plurality of condensed sub-beams). Finally, a different diffractive optical element 60 may be used, for example, replacing the previous diffractive optical element 60 to alter the distance between the spots.

The patterning device 10 may also comprise focusing means 80, for example, an f-θ-lens 80 which is movable in a direction parallel to the condensed sub-beams 40A, 40B, 40C for altering the location of the focus of the condensed sub-beams 40A, 40B, 40C. The patterning device 10 further comprises a driver 90 for the light source 50, for example, for controlling an intensity and/or color of the condensed light beam 40 emitted by the light source 50. The system also comprises control means 94 for controlling the scanning means 70, 72 to control the moving of the condensed sub-beams 40A, 40B, 40C, both in position and speed across the layer 32, 34. The control means 94 also controls the driver 90, for example, an intensity, pulse-frequency and beam-dimensions. The control means 94 may also comprise conversion means 96 for converting an input-pattern, being, for example, a digital representation of the pattern 20, 22, 24 to be produced on the layer 32, 34 into a movement of the condensed sub-beams 40A, 40B, 40C and/or into an intensity variation and/or speed variation of the condensed sub-beams 40A, 40B, 40C and/or a color variation of the condensed sub-beams 40A, 40B, 40C. The patterning device 10 may further comprise input means 98 for providing the input-pattern to the control means 94. The input-pattern may be in a specific format or a generic format in which the input-pattern is provided, for example, by a user to the patterning device 10. The input means 98 may also be connected to a network environment (not shown), for example, the internet. A customer may then simply upload the input-pattern to the control means 94 via a server (not shown).

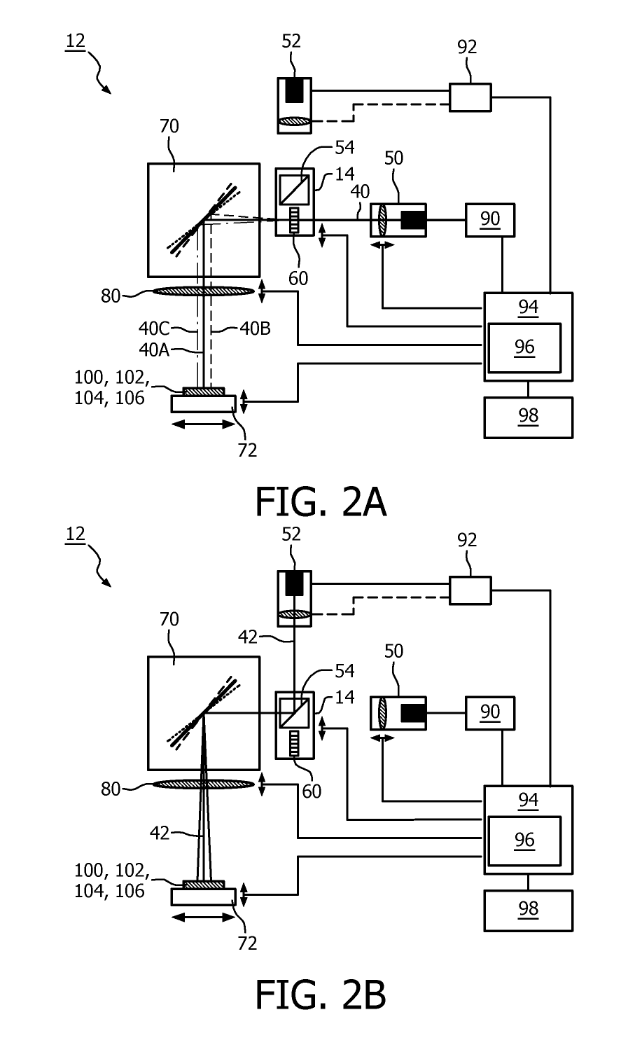

FIGS. 2A and 2B show a schematic view of a further embodiment of the patterning device 12 according to the invention. In this further embodiment of the patterning device 12, the patterning device 12 comprises a further light source 52 controlled by a further driver 92. The further light source 52 generates the further condensed light beam 42 (see FIG. 2B) which is redirected via a prism 54 toward the scanning means 70 for scanning the further condensed light beam 42 across the layer 32, 34. The further condensed light beam 42 preferably has a different spot-size and/or intensity compared to condensed light beam 40 of the light source 50. The patterning device 12 according to the FIGS. 2A and 2B further comprises means 14 to move the diffractive optical element 60 into and out of the optical path of the condensed light beam 40. The movable means 14 also comprise the prism 54, such that in a first position the diffractive optical element 60 is located in the optical path of the condensed light beam 40 such that the diffractive optical element 60 splits the condensed light beam 40 into the plurality of condensed sub-beams 40A, 40B, 40C, and in a second position of the means 14 the prism 54 is arranged such that the further condensed light beam 42 may be used for generating the pattern 20, 22, 24 via the scanning means 70. The control means 90, for example, dynamically selects the light source 50 or the further light source 52 while generating the pattern 20, 22, 24. Both the light source 50 and the further light source 52 may be calibrated such that the characteristics such as spot-size and power of both the condensed light beam 40 and the further condensed light beam 42 are well known. The control means 90 is thus able to relatively quickly switch from the light source 50 to the further light source 52 if required, typically much quicker than a patterning device which comprises a single light source 50 of which the spot-size and power must be adapted depending on the level of detail which must be patterned and whether or not a diffractive optical element 60 is present in the optical path. For example, the edges of a pattern 20, 22, 24 may be generated using the further light source 52 having a single condensed light beam 52 for generating a detailed pattern, while the center of the pattern 20, 22, 24 may be generated using the light source 50 together with the diffractive optical element 60 which generates multi-spot patterning for patterning the relatively large area on the layer 32, 34 using the plurality of condensed sub-beams 40A, 40B, 40C at a predefined regular interval from each other.

FIG. 2A shows a schematic representation of the patterning device 12 in which the diffractive optical element 60 is positioned in the optical path of the light source 50 for splitting the condensed light beam 40 into the plurality of condensed sub-beams 40A, 40B, 40C. FIG. 2B shows a schematic representation of the patterning device 12 in which the prism 54 is positioned in the optical path of the further light source 52 to redirect the further condensed light beam 52 toward the scanning means 70.

The patterning device 10, 12 as shown in FIGS. 1, 2A and 2B may further comprise calibration means for determining a spot-size of the condensed sub-beams 40A, 40B, 40C and/or for determining a spot-size of the further condensed light beam 42. Such calibration means may comprise sensors (not shown) for sensing the spot-size to be calibrated, for example, via a camera inspecting the generated pattern 20, 22, 24 in and/or on the layer 32, 34 and providing this camera image as feedback signal to the control means 94 for adapting the spot-size. The control means 94 may also be configured to control a patterning speed of the patterning device 10, 12. The calibration means may perform a calibration method in which the calibration method comprises the steps of:

setting initial parameters of the condensed sub-beams 40A, 40B, 40C and/or of the further condensed light beam 42,

locally irradiating the layer 32, 34 with the condensed sub-beams 40A, 40B, 40C and/or with the further condensed light beam 42 for generating a test-pattern (not shown), and

determining from the test-pattern an intensity and/or a scanning speed of the condensed sub-beams 40A, 40B, 40C and/or of the condensed light beam 42 for generating the pattern 20, 22, 24.

The method may further comprise the step of:

adapting the focus position of the condensed sub-beams 40A, 40B, 40C and/or of the condensed light beam 42 while generating a part of the test pattern.

Preferably the test-pattern is generated at an unused edge of the layer 32, 34 before generating the pattern 20, 22, 24. The dimensions of the test-pattern may be chosen to be substantially invisible to a naked human eye.

FIG. 3A shows a schematic view of the diffractive optical element 60 for splitting the condensed light beam 40 into condensed sub-beams 40A, 40B, 40C, and FIGS. 3B to 3D indicate the spots which are distributed on the layer 32, 34 while writing the pattern 20, 22, 24 using the diffractive optical element 60. In the schematic view of FIG. 3A the condensed light beam 40 is split into seven condensed sub-beams 40A, 40B, 40C while only three of the condensed sub-beams 40A, 40B, 40C have reference numbers attached to them. These three condensed sub-beams 40A, 40B, 40C may, for example, represent the further plurality of condensed sub-beams 40A, 40B, 40C which comprise substantially identical intensity. Alternatively, the diffractive optical element 60 may be designed such that all seven condensed sub-beams 40A, 40B, 40C have substantially identical intensity—that is within a few percent of the intensity of one of the condensed sub-beams 40A, 40B, 40C. The diffractive optical element 60 may, for example, comprise a binary phase grating 60, and/or a binary amplitude grating 60, and/or a variable phase grating 60, and/or a variable amplitude grating 60, and/or a holographic phase optical element 60, and/or a holographic amplitude optical element 60, and/or a holographic phase grating 60, and/or a holographic amplitude grating 60, and/or a spatial light modulator. Using such diffractive optical element 60, a one-dimensional or two-dimensional array of condensed sub-beams 40A, 40B, 40C may be generated. The diffractive optical element 60 splits the condensed light beam 40 by diffracting the condensed sub-beams 40A, 40B, 40C at different angles φ from the diffractive optical element 60. Preferably, the angle φ between each pair of adjacent condensed sub-beams 40A, 40B, 40C in a row of condensed sub-beams is substantially identical. This ensures a regular spacing between the spots resulting from the condensed sub-beams 40A, 40B, 40C impinging on the layer 32, 34. From FIG. 3A it can also readily be seen that the distance between the diffractive optical element 60 and the layer 32, 34 determines the distance d₁, d₂, d₃ (see FIGS. 3B to 3D) between the spots on the layer 32, 34. Alternatively, the diffractive optical element 60 may be rotated around a further angle α to optically alter the density of lines in the grating of the diffractive optical element 60 to alter the angle φ between each pair of adjacent condensed sub-beams 40A, 40B, 40C. Even further alternatively, the diffractive optical element 60 may be rotated in a plane coinciding with the grating of the diffractive optical element 60 which results in a varying of a distance d₃ between the spots when writing with the plurality of spots on the layer 32, 34. By rotating the diffractive optical element 60 in a plane substantially coinciding with the diffractive optical element 60, the array of spots is no longer arranged at 90 degrees with respect to the writing direction v (see FIGS. 3B to 3D) but arranged at an angle such that the distance d₃ between the spots while writing is reduced (see FIG. 3D).

FIGS. 3B to 3D provide a schematic representation of the spots which are distributed on the layer 32, 34 and which are used for writing the pattern 20, 22, 24 on the layer 32, 34. The arrow v indicates the writing direction v and the dots indicate the spots of the seven condensed sub-beams 40A, 40B, 40C generated by the diffractive optical element 60. FIG. 3B indicates an initial situation in which the distance d₁ represents the distance between the spots on the layer 32, 34. FIG. 3C indicates the spots when the diffractive optical element 60 may be rotated around the further angle α, or when the distance between the diffractive optical element 60 and the layer 32, 34 is reduced, or when the grating of the diffractive optical element is exchanged or adapted to have an increased distance between the lines in the grating. As can clearly be seen, the distance d₂ between the spots as shown in FIG. 3C is smaller compared to the distance d₁ between the spots as shown in the initial situation shown in FIG. 3B. FIG. 3D indicates the spots when the diffractive optical element 60 is rotated around an in-plane angle β which represents a rotation in the plane substantially coinciding with the diffractive optical element 60. As can be seen from FIG. 3D the orientation of the array of spots alters compared to the scan direction v providing a reduced distance d₃ between the spots when writing the pattern 20, 22, 24 using such an arrangement of the diffractive optical element 60. As can clearly be seen, the distance d₃ between the spots as shown in FIG. 3D is smaller compared to the distance d₁ between the spots as shown in the initial situation shown in FIG. 3B.

FIGS. 4A, 4B and 4C show schematic cross-sectional views of an OLED device 100, 102, 104 comprising local deformations 20A, 20B, 22A, 22B in and/or on a light-reflective layer 32, representing the pattern 20, 22, or comprising local damaging 24A, 24B of the light emitting layer 34, representing the pattern. The OLED devices 100, 102, 104 comprise a plurality of layers 30, 32, 34 comprising an anode layer 30 and a cathode layer 32 and a light emitting layer 34. The FIGS. 4A, 4B and 4C only show these three layers although a typical OLED device 100, 102, 104 comprise several more layers. The light emitting layer 34 comprises organic light emitting material 34M (see FIG. 6) which is configured to emit light when a current runs through the organic light emitting material 34M. Typically, the emission of light is based on the local recombination of electrons being a negatively charged particle (not shown) with holes being a representation of an imaginary positively charged particle (not shown). The recombination of such electron-hole pair at the organic light emitting material 34M results in an excitation which can decay with the emission of light of a predefined color. The OLED device 100, 102, 104 may comprise a single layer of light emitting material 34M which is arranged for emitting a predefined color of light when an electron-hole pair recombines. Alternatively, the OLED device 100, 102, 104 may comprise a plurality of layers of light emitting material 34M (not shown) each emitting, for example, a different color, or the light emitting layer 34M may comprise a mix of light emitting materials which emit different colors and which together emit, for example, white light of a predefined color temperature. As such, the color of the light emitted by the OLED device 100, 102, 104 may be determined by choosing a plurality of layers and/or by choosing a specific mixture of light emitting materials in the light emitting layer 34M. The OLED device 100, 102, 104 further comprises the anode layer 30 and the cathode layer 32. The anode layer 30 may, for example, comprise of ITO being a metal being transparent for a specific range of light, allowing the light generated in the OLED device 100, 102, 104 to be emitted from the OLED device 100, 102, 104 via a light-emission window 120. The cathode layer 32 may, for example, comprise a 2 nanometers Barium layer and a 100 nanometers Aluminum layer which has good conductive characteristics and which may be well applied in semiconductor manufacturing processes.

In the embodiment of the OLED device 100, 102 as shown in FIGS. 4A and 4B, the Aluminum layer constituted a light-reflective layer 32 which reflects light generated in the light emitting layer 34 towards the light-emission window 120. Of course, the anode layer 30 and cathode layer 32 may be exchanged such that the light may be emitted from the OLED device 100, 102 via the cathode layer 32. The ITO-layer is often applied on a substrate 130 for supporting the OLED device 100, 102 and which is also substantially transparent to the light emitted by the OLED device 100, 102. The OLED device 100, 102, 104 as shown in FIGS. 4A and 4B comprise a pattern 20, 22, which is permanently visible both in the on-state of the OLED device 100, 102 and in the off-state of the OLED device 100, 102. The on-state is defined as a state during which a potential difference between the anode 30 and the cathode 32 produces a current through at least a part of the light emitting layer 34 for generating light by the OLED device 100, 102, and the off-state of the OLED device 100, 102 is defined as a state during which no potential difference is present between the anode 30 and cathode 32. The pattern 20, 22 is constituted of deformations 20A, 22A, 20B, 22B of the Aluminum layer 32 being the light-reflective layer 32.

During the off-state of the light emitting diode device 10, 12 ambient light (not shown) enters the OLED device 100, 102 via the light-emission window 120. As the anode layer 30 and the light emitting layer 34 are both at least partially transparent, part of the ambient light will be transmitted by the anode layer 30 and the light emitting layer 34 and impinge on the light-reflective cathode layer 32 which reflects this light back to the light-emission window 120. The part of the ambient light which impinges on the deformations 20A, 20B, 22A, 22B will be scattered, and thus the pattern constituted of the deformations 20A, 20B, 22A, 22B on the light-reflective layer 32 will be clearly visible via the light-emission window 130. During the on-state of the OLED device 100, 102 a current runs through the light emitting layer 34 and the light emitting layer 34 emits light. This light is emitted substantially in all directions. Some of the generated light progresses towards the light-reflective cathode layer 32 is reflected by the cathode layer 32 towards the light-emission window 120. Light impinging on the local deformations 20A, 20B, 22A, 22B in the light-reflective layer 32 will be scattered by these deformations which is clearly visible through the light-emission window 120.

The deformations 20A, 20B, 22A, 22B may be produced using condensed sub-beams 40A, 40B, 40C as is indicated with three arrows 40A, 40B, 40C in both FIGS. 4A and 4B. The height h of the deformations 20A, 20B, 22A, 22B depends on the power of the condensed sub-beams 40A, 40B, 40C and on a thickness of the light-reflective layer 32. The height h contributes to determine the level of scattering of light from the deformations 20A, 20B, 22A, 22B and thus determines the visual effect obtained by the deformations 20A, 20B, 22A, 22B. Also the density of the deformations 20A, 20B, 22A, 22B is used to obtain visual effects. As such, the deformations comprising the reference numbers 20A, 22A are placed relatively close together and are perceived as having a darker grey-value compared to the deformations comprising the reference numbers 20B and 22B. Preferably the deformations 20A, 22A, 20B, 22B in the light-reflective layer 32 are produced without damaging any of the layers of the OLED device 100, 102 which are used for the light emission. As the deformations 20A, 22A, 20B, 22B are generated in the light-reflective layer 32 such that substantially the conductivity of the light-reflective layer 32 is maintained, the whole light emitting surface of the light emitting diode device 10, 12 will radiate light while the pattern 20, 22 remains visible.

The OLED device 100, 102 typically is sealed in an encapsulation 110 to protect the OLED device 100, 102 from environmental influences. A part 112 of the encapsulation 110 may be configured to be substantially transparent to the light of the condensed sub-beams 40A, 40B, 40C. In the embodiment of FIG. 4A, the part 112 which is substantially transparent to light of the condensed sub-beams 40A, 40B, 40C is located on a rear-wall 33 of the light-reflective layer 32 to generate the deformations 20A, 20B. The rear-wall 33 of the light-reflective layer 32 is a side of the light-reflective layer 32 facing away from the light-emission window 120. A benefit of this arrangement is that the condensed sub-beams 40A, 40B, 40C do not need to be transmitted by the substrate 130, the anode layer 30 and the light emitting material 34 before impinging on the light-reflective layer 32 to generate the deformations. This would reduce a possibility that the condensed sub-beams 40A, 40B, 40C would damage any of the layers of the OLED device 100 rather than generate the deformations 20A, 20B. Furthermore, the rear-wall 33 of the light-reflective layer 32 does not need to be reflective. If the rear-wall 33 of the light-reflective layer 32 would not be reflective, the rear-wall 33 would more easily absorb the light from the condensed sub-beams 40A, 40B, 40C to generate the deformations 20A, 20B and thus a less powerful array of condensed sub-beams 40A, 40B, 40C is required for generating the deformations 20A, 20B.

In the embodiment of the OLED device 102 as shown in FIG. 4B, the encapsulation 110 fully seals the OLED device 102 and does not allow the condensed sub-beams 40A, 40B, 40C to impinge on the rear-wall 33. As such, the condensed sub-beams 40A, 40B, 40C impinges on the light-reflective layer 32 via the substrate 130, the at least partially transparent anode layer 30 and the light emitting material 34 to generate the deformations 22A, 22B.

In the embodiment of the OLED device 104 as shown in FIG. 4C, again the encapsulation 110 fully seals the OLED device 104. Again the condensed sub-beams 40A, 40B, 40C irradiate into the OLED device 104 via the substrate 130 and the at least partially transparent anode layer 30. However, subsequently the impinging condensed sub-beams 40A, 40B, 40C locally damages the light emitting layer 34 to create the pattern 24. Due to the local damaged areas 24A, 24B no light can be generated at these damaged areas 24A, 24B and as such, when the OLED device 104 is switched on, the pattern 24 is visible as parts which emit substantially no light. Again, the density of the damaged area 24A, 24B represent perceived grey-values in the pattern 24 in which the dense area 24A is perceived as a darker grey-value compared to the less dense area 24B.

FIGS. 5A and 5B show a detailed representation of the local deformations 20B, 22B. In FIG. 5A a detailed part of a letter “P” is shown. The deformations 20B, 22B are generated in lines arranged diagonally. The lines of deformations constituting the pattern 20, 22 of FIG. 5A are shown in more detail in FIG. 5B. Choosing a right power of the condensed sub-beams 40A, 40B, 40C a real multi-spot patterning may be done for patterning relatively large areas using the plurality of condensed sub-beams 40A, 40B, 40C at a predefined regular interval.

FIG. 6 shows a schematic cross-sectional view of an OLED device 106 in which the current support layers 34A . . . 34L are locally altered for generating the pattern. The OLED device 106 comprises of a plurality of layers 34A . . . 34M constituting the OLED device 106. In the example shown in FIG. 6 the OLED device 106 comprises an organic light emitting material 34M which is embedded in an organic host material. This organic light emitting material 34M is configured to emit light when a current runs through the organic light emitting material 34M. Typically, the emission of light is based on the local recombination of electrons being a negatively charged particle (not shown) with holes being a representation of an imaginary positively charged particle (not shown). The recombination of such electron-hole pair at the organic light emitting material 34M results in an excitation which can decay with the emission of light of a predefined color. The OLED device 106 may comprise a single layer of light emitting material 34M which is arranged for emitting a predefined color of light when an electron-hole pair recombines. Alternatively, the OLED device 106 may comprise a plurality of layers of light emitting material 34M each emitting, for example, a different color, or comprise a mix of light emitting materials which emit different colors and which together emit, for example, white light of a predefined color temperature. The OLED device 106 further comprises one or a plurality of current support layers 34A . . . 34L which are used to enable and/or assist and/or dimension the current flowing, in operation, through the light emitting material 34M to cause the light emitting material 34M to emit light. In the patterned OLED device 106, the pattern is generated in at least one of the current support layers 34A . . . 34L while substantially not altering the anode 30, cathode 32 or the light emitting material 34M.

With the term current support layer 34A . . . 34L a layer which influences the flowing of current through the light emitting material 34M is meant with the exception of the anode layer 30, the cathode layer 32 and the light emitting material 34M. Examples of the current support layer 34A . . . 34L are: a current blocking layer 34A, an interface layer of the current blocking layer 34B, a hole blocking layer 34C and an electron blocking layer (not shown), an electron injection layer 34D, an interface of the electron injection layer 34E, a injection inhibition layer 34F, an interface layer of the injection inhibition layer 34G, a hole injection layer 34H, an interface of the hole injection layer 34I, an interface layer of the cathode layer 34J, an interface layer of the anode layer 34K and a host layer 34L. Any of these listed current support layers 34A . . . 34L influences, in operation, the flowing of the current through the organic light emitting layer 34M. Locally adapting a characteristic of one of these listed current support layers 34A . . . 34L will locally alter the current which flows in operation through the organic light emitting material, thus locally altering the emission characteristic. The host layer 34L may be used to keep the emission zone (around the dye) physically away from the electrodes 30, 32 to avoid non-radiative excitation quenching and to tune the optical stack for optimum light output. When the OLED device 106 is switched on, these altered emission characteristics are clearly visible and may be applied in a required pattern which is clearly visible when the OLED device 106 is switched on. Because the organic light emitting layer 34M, the anode layer 30 or the cathode layer 32 are not influenced, the pattern is substantially invisible, even when the OLED device 106 is irradiated with, for example, ultraviolet light

The OLED device 106 may comprise any of the above listed layers 34A . . . 34L but clearly does not need to contain all of the listed layers 34A . . . 34L. The current blocking layer 34A, may be located almost anywhere in the OLED device 106 and has been indicated in the OLED device 106 on top of the anode layer 30 being an ITO-layer. The interface of current blocking layer 34B may be located on either side of the current blocking layer 34A, preferably between the current blocking layer 34A and the anode layer 30 (facing the ITO layer) as this is often the only transparent layer in a finished OLED device 106. The injection inhibition layer 34F may be on either side of the respective hole injection material 34H and electron injection material 34D. The hole blocking layer 34C prevents electrons and holes from recombining (without the emission of light!) near the cathode layer 32, but keeps the holes close to the active recombination region of the device. The OLED device 106 shown in FIG. 1 is typically a smOLED as many current supporting layers are present. The polymer OLED device typically requires less current supporting layers and thus typically has reduced complexity. A typical polymer OLED device comprises the anode layer 30, generally an ITO layer 30, comprises optionally a hole injection layer (equivalent to the hole injection layer 34H of FIG. 6), light emitting polymer (equivalent to the light emitting layer 34M in FIG. 6) and a cathode layer 32 being the top electrode constituted, for example, of a 2 nanometers Barium layer and a 100 nanometers Aluminum layer.

By selectively influencing the current support characteristic of individual current support layers 34A . . . 34L different patterns may be produced in different current support layers 34A . . . 34L. This would enable to generate a color pattern in the OLED device 16. As the influencing of the current support characteristic may be done via light induced changes using the condensed sub-beams 40A, 40B, 40C, the selective altering may be done by carefully choosing a specific wavelength of light to induce the light induced changes and/or by carefully tuning the power of the light used to obtain the light induced change.

The current support characteristic of the current support layer 34A . . . 34L may be altered to several degrees or to different extents, enabling to generate a plurality of grey-levels in the pattern. The inventors have found that the current support characteristics of a current support layer 34A . . . 34L may be altered to different extents for example, by altering a light flux impinging on a specific current support layer. The inventors have found that the change in the current support characteristic is substantially proportional to the total flux of photons at a specific location. As such, a plurality of grey-levels may be introduced which manifest themselves as local intensity variations caused by corresponding local light flux variations. Light flux variations may, for example, be generated by altering an intensity of the condensed sub-beams 40A, 40B, 40C. Alternatively, the energy per photon, or said differently, the color of the light emitted by the condensed sub-beams 40A, 40B, 40C may be altered to influence the level of altering the current support characteristics and as such generate grey-levels in the pattern generated on the OLED device 106.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A patterning device for generating a pattern in and/or on a layer via a condensed light beam, the patterning device comprising:
a light source for generating the condensed light beam,
a diffractive optical element for splitting the condensed light beam into a plurality of condensed sub-beams configured for generating the pattern in and/or on the layer, at least two sub-beams of the plurality of condensed sub-beams comprising substantially equal intensity, and
positioning means for positioning the layer relative to the plurality of condensed sub-beams for generating the pattern.

2. Patterning device according to claim 1, wherein the diffractive optical element is configured for splitting the condensed light beam into a one-dimensional array of condensed sub-beams or into a two-dimensional array of condensed sub-beams, a further plurality of the condensed sub-beams of the one-dimensional array of condensed sub-beams or of the two-dimensional array of condensed sub-beams comprising substantially equal intensity.

3. Patterning device according to claim 1, wherein the diffractive optical element is selected from the group consisting of: a binary phase grating, a binary amplitude grating, a variable phase grating, a variable amplitude grating, a holographic phase optical element, a holographic amplitude optical element, a holographic phase grating, a holographic amplitude grating, and a spatial light modulator.

4. Patterning device according to claim 1, wherein each of the condensed sub-beams comprising substantially equal intensity comprise an intensity sufficient to generate the pattern in and/or on the layer.

5. Patterning device according to claim 1, wherein an angle between each pair of adjacent condensed sub-beams in a row of condensed sub-beams is substantially identical.

6. Patterning device according to claim 1, wherein the diffractive optical element is configured for adapting a number of the condensed sub-beams and/or an intensity of the condensed sub-beams, wherein:
the diffractive optical element comprises pixels comprising translucent material comprising an adaptable refractive index of the translucent material, and/or
the diffractive optical element comprises a plurality of different gratings each generating a predefined number of condensed sub-beams and/or a predefined intensity of the condensed sub-beams, the diffractive optical element being movable with respect to the condensed light beam for aligning the condensed light beam with one of the plurality of different gratings, and/or

7. Patterning device according to claim 1, wherein the diffractive optical element is configured for being movable into the optical path of the condensed light beam for generating the plurality of condensed sub-beams, and for being movable out of the optical path of the condensed light beam.

8. Patterning device according to claim 1, wherein the layer is part of an organic light emitting diode device.

9. Patterning device according to claim 8, wherein the layer:
is a light-reflecting layer of the organic light emitting diode device, the patterning device being configured for generating local deformations of the light-reflective layer for generating the pattern, or
is a light-emitting layer of the organic light emitting diode device, the patterning device being configured for locally damaging the light-emitting layer for generating the pattern, or
is a current support layer of the organic light emitting diode device, the patterning device being configured for locally altering a current support characteristic of the current support layer while not substantially altering an organic light emitting material, an anode layer nor a cathode layer, the current support characteristic locally determining the current flowing through the organic light emitting material in operation.

10. Patterning device as claimed in claim 8, wherein the patterning device is configured for generating the pattern in and/or on the layer through an encapsulation of the organic light emitting diode device.

11. Patterning device as claimed in claim 9, wherein a density of the local deformations of the light-reflective layer, and/or a dimension of the local deformations of the light-reflective layer, and/or a density of the local damages to the light-emitting layer, and/or a density of local altering of the current support characteristic of the current support layer, and/or a level of altering of the current support characteristic of the current support layer constitutes a perceived grey-level.

12. Patterning device as claimed in claim 1, wherein the light source is a laser light source and/or a laser diode

13. Patterning device as claimed in claim 1, wherein the light source is configured for generating a condensed light beam and/or condensed sub-beams in a range between 320 nanometers and 2000 nanometers.

14. Patterning device as claimed in claim 1, wherein the patterning device comprises focusing means for controlling a focus location of the condensed light beam and/or condensed sub-beams.

15. Patterning device as claimed in claim 1, wherein the patterning device comprises means for controlling an energy level of the condensed light beam and/or condensed sub-beams, and/or a color of the condensed light beam and/or condensed sub-beams, and/or a speed for altering a position of the layer relative to the condensed light beam and/or condensed sub-beams.

16. Patterning device as claimed in any of the previous claims, wherein the patterning device further comprises input means for accepting an input-pattern for being generated as the pattern in and/or on the layer, and comprises conversion means for converting the input-pattern into a positioning of the condensed light beam and/or the condensed sub-beams relative to the layer, and/or into a spot-size of the condensed light beam and/or condensed sub-beams, and/or into an intensity variation of the condensed light beam and/or condensed sub-beams, and/or into a color variation of the condensed light beam, and/or condensed sub-beams for generating the pattern.
